(19) United States
(12) Patent Application Publication
(10) Pub. No.: US 2011/0196957 A1
(43) Pub. Date: Aug. 11, 2011

(54) Real-Time Policy Visualization by Configuration Item to Demonstrate Real-Time and Historical Interaction of Policies

(75) Inventors: Naga A. Ayachitula, Elmsford, NY (US); Vijaya Jas, Austin, TX (US); Kenneth D. Christiance, Cary, NC (US); Peter M. Jensen, Sherwood, OR (US); Josephine E. Justin, Bangalore (IN); Robert Larsen, Hawthorn Woods, IL (US); Ann M. Moyer, Woodstock, NY (US); Lisa Nayak, Austin, TX (US); Rajeev Puri, Charlotte, NC (US); Cheranellore Vasudevan, Bastrop, TX (US); Chetna D. Warade, Dracut, MA (US)

(73) Assignee: INTERNATIONAL BUSINESS MACHINES CORPORATION, Armonk, NY (US)

(21) Appl. No.: 12/701,052

(22) Filed: Feb. 5, 2010

(51) Int. Cl. G06F 15/16; G06N 5/02

(52) U.S. Cl. 709/224; 706/50; 709/223

(57) ABSTRACT

Multiple policy engines may be integrated with a change and configuration change database to enable coordination of multiple policies by an embodiment comprising: a data center having a plurality of configuration items and connected to a network; a database connected to the network; a plurality of policy engines connected to the network; wherein each of the plurality of policy engines is configured to apply one or more policies to the data center in accordance with an awareness of all configuration item changes made by all other policy engines connected to the network; wherein the awareness comprises a plurality of relationships, each relationship being between a policy data and a configuration item.

### BACKGROUND

1. Field

The disclosure relates generally to change and configuration management, and more specifically to an integration of multiple policy engines with a change and configuration change database to enable coordination of multiple policies.

2. Description of the Related Art

The information technology infrastructure library (ITIL) is a resource for information technology organizations that sets forth cross-disciplinary objectives for best practice processes and information technology governance and compliance. The information technology infrastructure library developed a concept for a configuration management database (CMDB) in which a database becomes a system for accessing trusted sources of information based on pre-defined policies applied to configuration items (CI). The pre-defined policies can cover any configuration item facing an information technology organization.

Policy is an approach for both governance and automation. Governance constrains behavior of people and resources. Automation replaces or supplements human actions with automated actions. Configuration management databases hold resource configuration data and relationships among the resources, among other information.

Investigation or resolution of an issue reported in a service request, incident, or problem report often results in creating work orders or process requests that affect one or more configuration items. The service request, incident, or problem report record provides several menu options that help you assess the impact of configuration item changes before you create a work order or process request.

A configuration item is a component that is considered part of an information technology infrastructure, such as a computer system or software application. A configuration item is managed through database records that identify its attributes and relationships to other configuration items, and through processes that support changes to a configuration item without adversely impacting the information technology environment. Configuration items vary in complexity and size from an entire service which may consist of hardware, software, and documentation to a single program module or a minor hardware component. The lowest-level configuration item is usually the smallest unit that can be changed independently of other components.

The configuration management of configuration items can focus on the process in which configuration item modifications are made after review and deliberation. However, the configuration management database is evolving toward real-time management using pre-defined policies. Therefore, rather than deliberation and review, multiple policy engines may act independently without knowledge of actions taken or that could be taken by other policy engines.

Accordingly, there is a need for a method and apparatus, which takes into account one or more of the issues discussed above as well as other possible issues.

### SUMMARY

According to one embodiment, an apparatus comprises a data center having a plurality of configuration items and connected to a network; a database connected to the network; a plurality of policy engines connected to the network; wherein each of the plurality of policy engines is configured to apply one or more policies to the data center in accordance with an awareness of all configuration item changes made by all other policy engines connected to the network; wherein the awareness comprises a plurality of relationships, each relationship being between a policy data and a configuration item.

According to another embodiment, a method comprises storing a plurality of configuration items in a database, connecting the database to a plurality of policy engines by a network, configuring each of the plurality of policy engines to apply one or more policies to the data center in accordance with an awareness of all configuration item changes made by all other policy engines connected to the network, and wherein the awareness comprises a plurality of relationships, each relationship being between a policy data and a configuration item.

According to another embodiment, a program product comprises a computer readable medium; a plurality of instructions stored on the computer readable medium, the plurality of instructions configured to cause a processor of a computer to perform actions comprising configuring each of a plurality of policy engines to apply one or more policies to a data center in accordance with an awareness of all configuration item changes made by all other policy engines connected to the network; wherein the awareness comprises a plurality of relationships, each relationship being between a policy data and a configuration item.

### BRIEF DESCRIPTION OF THE SEVERAL VIEWS OF THE DRAWINGS

FIG. 1 is computer network in which illustrative embodiments may be implemented;

FIG. 2 is data processing system in which illustrative embodiments may be implemented;

FIG. 3 is a data management environment in which illustrative embodiments may be implemented;

FIG. 4 is a data flow diagram of the data management environment in which illustrative embodiments may be implemented;

FIG. 5 is a flowchart of a get configuration item identification process in accordance with the illustrative embodiments;

FIG. 6 is a flowchart of a get policy definition process in accordance with the illustrative embodiments;

FIG. 7 is a flowchart of a get policy process in accordance with the illustrative embodiments;

FIG. 8 is a flowchart of a get change identification process in accordance with the illustrative embodiments;

FIG. 9 is a flowchart of a get change history process in accordance with the illustrative embodiments;

FIG. 10 is a flowchart of a get configuration item identification list process in accordance with the illustrative embodiments;

FIG. 11 is a flowchart of a get configuration item attributes process in accordance with the illustrative embodiments; and

FIG. 12 is a flowchart of a policy coordination process in accordance with the illustrative embodiments.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module”, or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction running system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

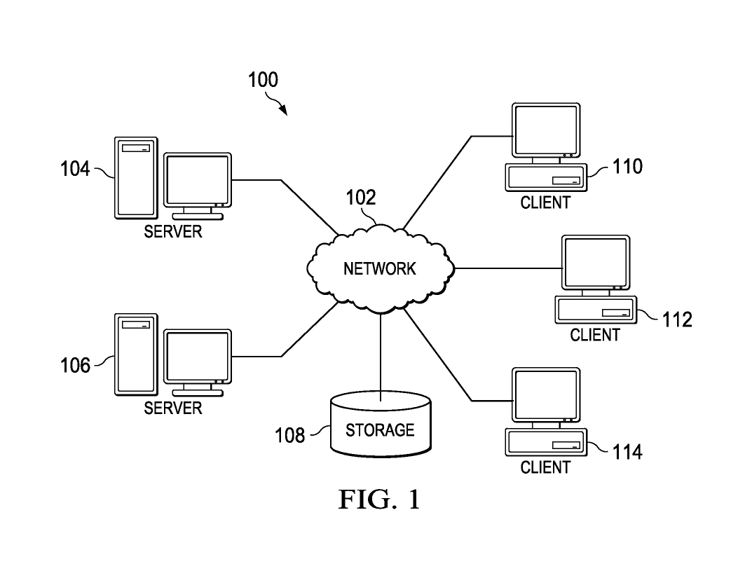

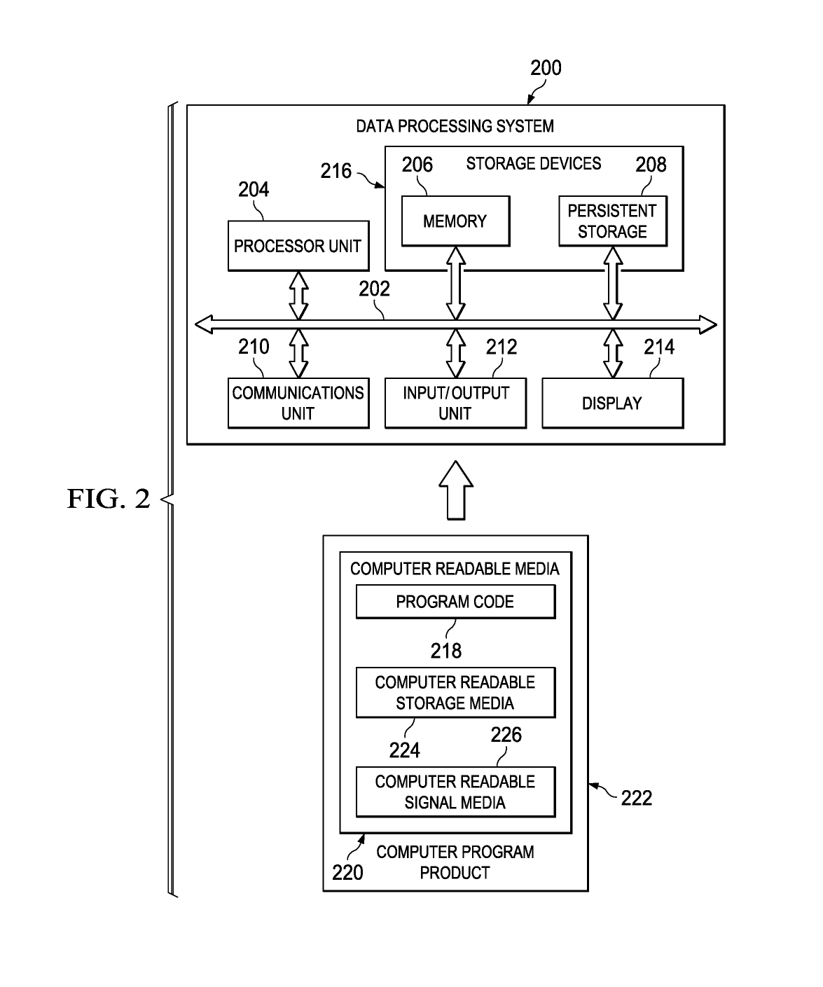

With reference now to the figures, and in particular, with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides information, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation, for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors, or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communication links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples the instructions are in a functional form on persistent storage 208. These instructions may be loaded into memory 206 for running by processor unit 204. The processes of the different embodiments may be performed by processor unit 204 using computer implemented instructions, which may be located in a memory, such as memory 206.

These instructions are referred to as program code, computer usable program code, or computer readable program code, that may be read and run by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for running by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communication links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208 and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

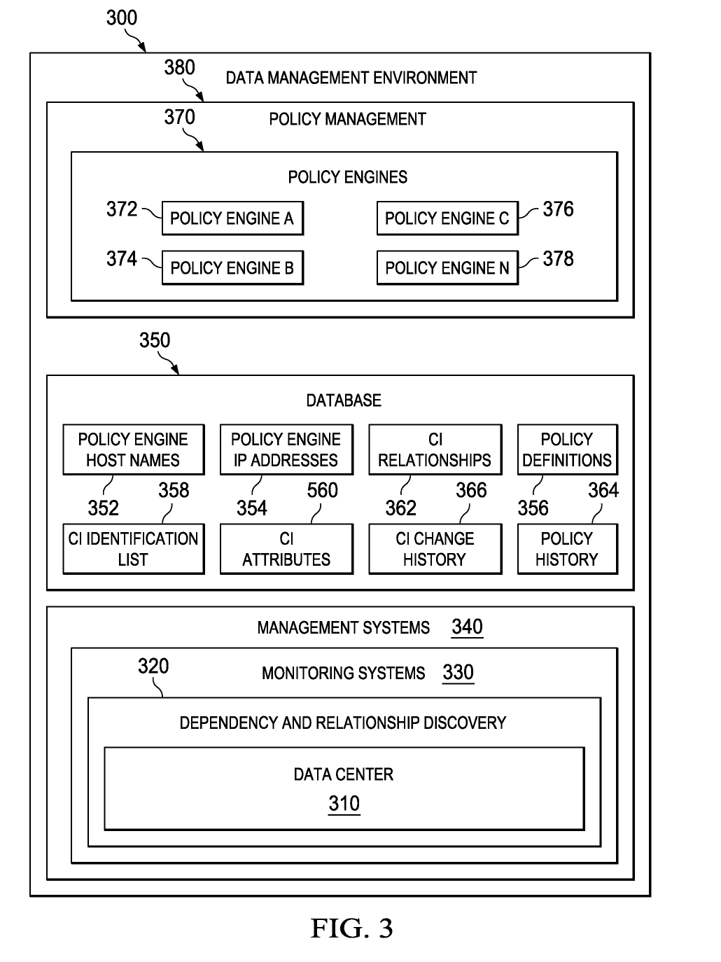

In an embodiment, FIG. 3 may be a data management environment 300. Data management environment 300 may include policy management portion 380, database 350, and management systems portion 340. In an embodiment, management systems portion 340 may be an automation platform or a system configured to provide a number of instructions to a user. Policy management portion 380 may comprise policy engines portion 370. Policy engines portion 370 may comprise a number of policy engines. As used herein, the term number means one or more. In an embodiment, the number of policy engines may be policy engine A 372, policy engine B 374, policy engine C 376 and policy engine N 378. Policy engines portion 370 may include any number of policy engines and policy engine N may represent any number as the last policy engine in policy engines portion 378. As will be discussed further below, policy engines may send data to apply policy, disable CPUs, enable CPUs, adjust CPU speed, and to make other changes to management system control based on policies stored in database 350. In an embodiment, each of a plurality of policy engines may have read access to historical policy management data through the relationship to configuration items established in data management environment 300. In an embodiment, the data model of database 350 and application programming interface functions may be extended to allow the policy engines to store policy definitions and policy decision history in database 350.

In an embodiment, all policy engines may have real-time access to accurate and relevant configuration item data and policy management data. The real-time access of all policy engines to configuration item data may be through access to a number of data groups in database 350, policy management functions in policy management portion 380, and performance data in monitoring systems 330.

Database 350 includes, without limitation, a number of data groups such as policy engine host names 352, policy engine internet protocol addresses 354, policy definitions 356, configuration item identification list 358, configuration item attributes 560, configuration item relationships 362, policy history 364, and configuration item change history 366. The quality of the action being performed in the data management environment in response to multiple independent policy engines may increase because each policy engine may act with an understanding of the policy engine actions that have been applied to configuration items by each of the other policy engines. In an embodiment, the understanding of the policy engine actions that have been applied to configuration items by each of the other policy engines may be a partial understanding. In an embodiment, the understanding of the policy engine actions that have been applied to configuration items by each of the other policy engines may be a complete understanding. As used herein, understanding means real time access to all information available for each configuration item and each policy definition in a number of locations in database 350. In an embodiment, the number of locations may be one or more of the following: configuration item relationships 362, configuration item identification list 358, configuration item change history 366, policy engine host names 352, policy engine internet protocol addresses 354, policy definitions 356, and policy history 364. As used herein, “awareness” means an understanding of a plurality of relationships, each relationship being between a policy data and a configuration item.

Database 350 may be a configuration management database. In an embodiment, database 350 may be an information technology infrastructure library aligned change and configuration management database. In an embodiment, database 350 has an enhanced schema to support storage of XML based policy definitions. In an embodiment, the policy definitions may be current policy definitions and may also be historical policy definitions. In an embodiment, the change and configuration management database schema is extended to support a service oriented architecture to allow users to view hierarchical configuration item policy definitions. In an embodiment, change and configuration management database change management functions are used to track policy driven configuration changes. In an embodiment, the database is Information Technology Infrastructure Library aligned so that service management systems provide an ability to discover, display, and manage configuration items and their dependencies. Further, in an embodiment, the database provides a hierarchical view on policy actions that represent real-time actions, along with a history view for actions performed within a time period such as an hour, a day, a week, or a month.

Management systems portion 340 may include monitoring systems 330, dependency and relationship discovery 320, and data center 310. In an embodiment, monitoring systems 330 may provide information regarding actions taken in regard to data center 310. In an embodiment, dependency and relationship discovery 320 may be a system, an engine, or a number of code segments that identify dependencies and relationships among configuration items in data center 310 and store the identified dependencies and relationships in configuration item relationships 362 of database 350.

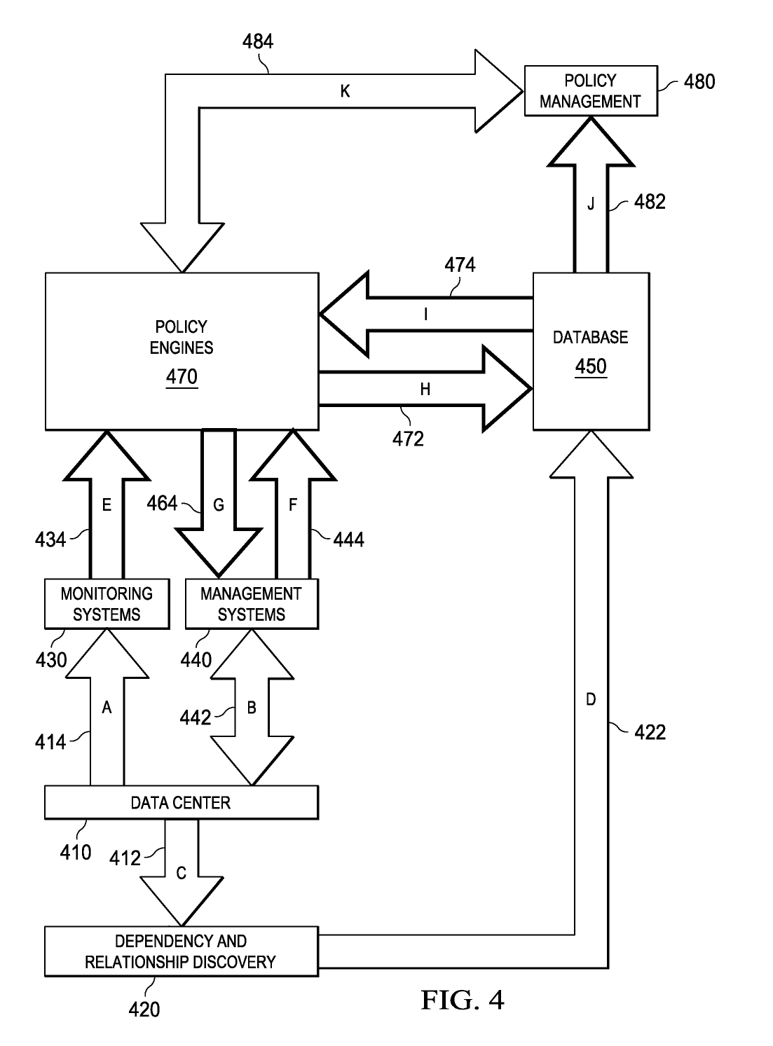

In an embodiment, FIG. 4 may be a diagram of data flow with the components of a data management system such as data management system 300. Data flow A 414 is a one-way flow of data from data center 410 to monitoring systems 430. Data center 410 may be a data center such as data center 310 in data management environment 300. Data flow B 442 is a bi-directional data flow between data center 410 and management systems 440. Management systems 440 may be a management systems portion such as management systems portion 340 of data management environment 300. Data flow C 412 is a one-way flow from data center 410 to dependency and relationship discovery portion 420. Dependency and relationship discovery 420 may be a dependency and relationship discovery portion such as dependency and relationship discovery portion 320 of data management environment 300. Data flow D 422 is a one-way flow from dependency and relationship discovery 420 to database 450.

Data flow E 434 may be a one way flow from monitoring systems 430 to policy engines 470. Data sent in data flow E 434 may be values for fault conditions, central processing unit utilization, memory utilization, system temperatures, central processing unit speeds, and other indicators of system performance known to persons skilled in the art. Data flow F 444 may be a one-way flow from monitoring systems 430 to policy engines 470. Data flow F 444 may comprise values for central processing unit speed, central processing units enabled, system temperature, and other management goals known to persons skilled in the art. Data flow G 464 applies policies, disables central processing units, enables central processing units, or adjusts central processing unit speed.

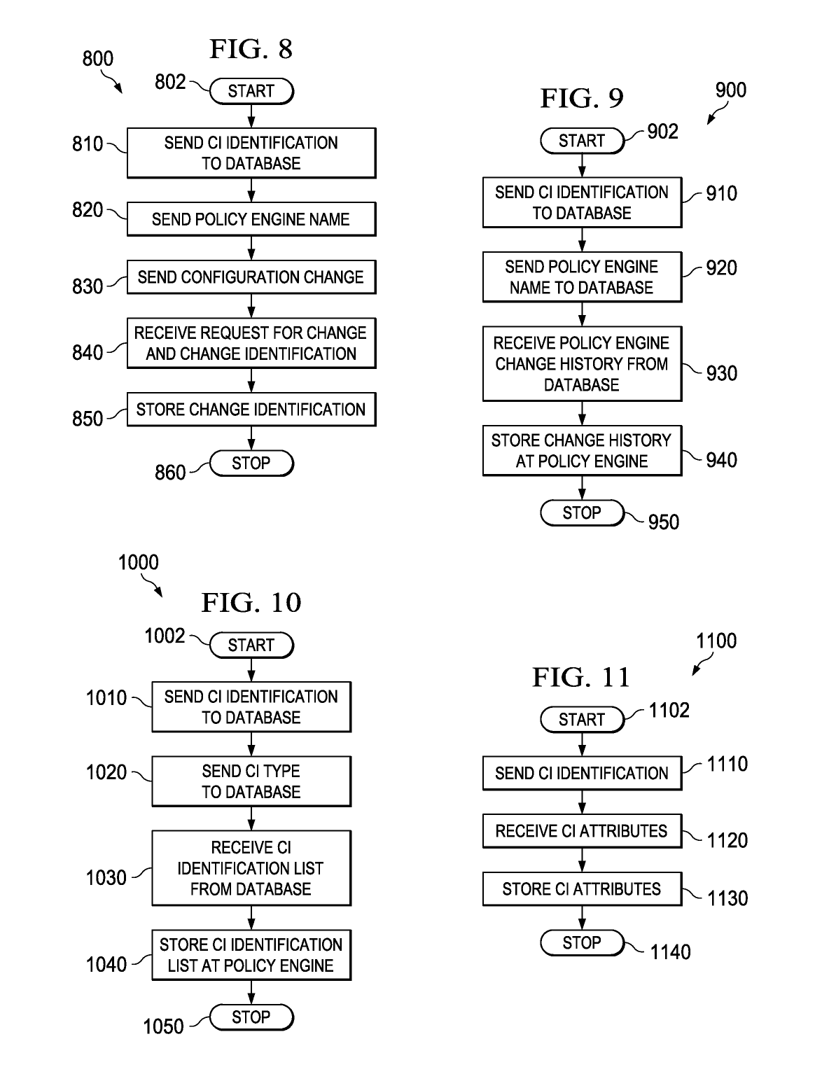

Data flow H 472 may be a one-way flow from policy engines 470 to database 450. Policy engines 470 sends data regarding configuration item policies, applied configuration changes, and other policy engine data known to persons skilled in the art. In particular, data flow H 472 enables write policy process 600 (see FIG. 6) and write policy change process 800 (see FIG. 8).

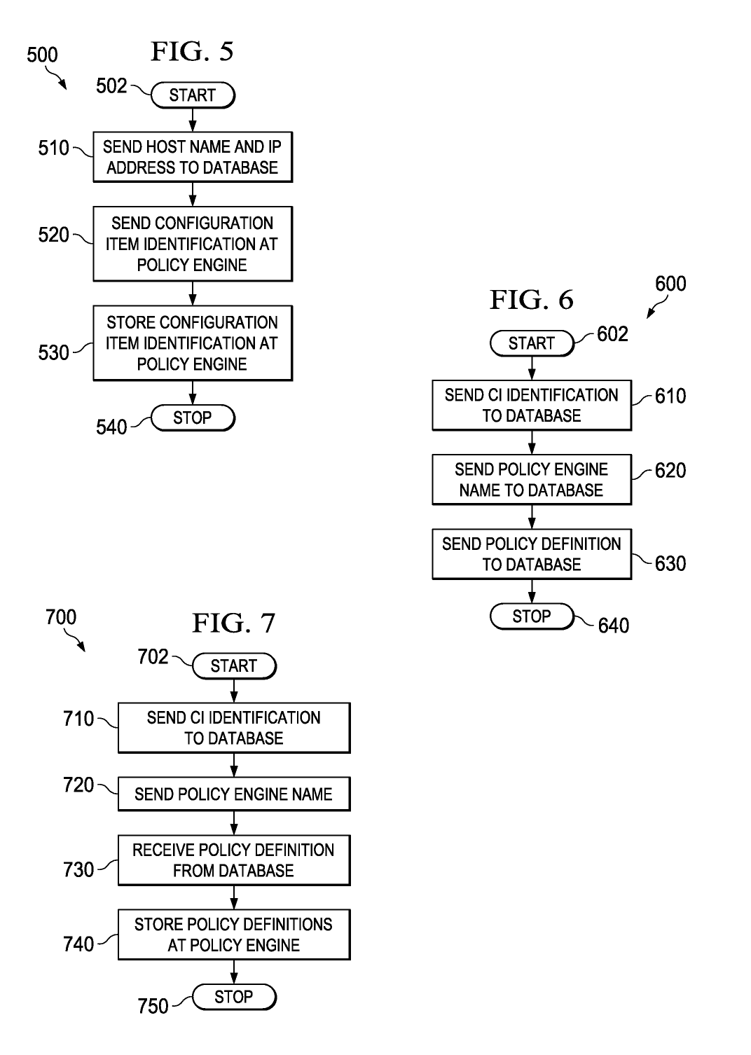

Data flow 1474 may be a one-way flow from database 450 to policy engines 470. Data flow 1474 sends data regarding configuration item attributes, configuration item relationships, configuration item change history, and stored policies. Referring to FIG. 3, configuration item attributes may be configuration item attributes 360, configuration item relationships may be configuration item relationships 362, configuration item change history may be configuration item change history 366, and stored policies may be policy definitions 356. In particular, data flow 474 enables get configuration item process 500 (see FIG. 5), get policy process 700 (see FIG. 7), get configuration item relationships 1000 (see FIG. 10), and get configuration item attributes 1100 (see FIG. 11).

Data flow J 482 may be a one-way flow from database 350 to policy management portion 480. Data flow J 482 sends a number of configuration item attributes, configuration item relationships, configuration item change history, policy definitions, and policy history. In particular, data flow J 482 enables get policy process 700 (see FIG. 7), get policy change history 900 (see FIG. 9), get configuration item relationships 1000 (see FIG. 10), and get configuration item attributes 1100 (see FIG. 11).

Data flow K 484 may be a two-way flow from policy engines 470 to policy management portion 480 and vice versa. Data flow K 484 provides policy engines 470 with current information on controls imposed by management systems 440. Together, data flow F 444 and data flow K 484 provide policy engines 470 with both the control values and the actual performance values in real-time for data center 410.

In an embodiment, FIG. 5 may be a flowchart of get configuration process 500. Get configuration process 500 starts (502) and the policy engine sends a host name and an internet protocol address to database 450 (510). The policy engine may be any policy engine included in policy engines 470. In return, database 450 provides the policy engine with a configuration item identification (520). Configuration item identification may be a globally unique identifier (GUID). The configuration identification may be stored at the policy engine (530) and get configuration item process 500 stops (540).

In an embodiment, FIG. 6 is a flowchart of a send policy definitions process 600. Policy definitions process starts (602) and a policy engine sends a configuration item identification to the database (610). The policy engine then sends policy definitions to the database (630), and stops (640).

In an embodiment, FIG. 7 may be a flowchart of get policy process 700. Get policy process 700 starts (702) and sends a configuration item identification to a database, such as database 350 of FIG. 3. Next, get policy process 700 sends policy engine name (720). Finally, get policy process 700 receives policy definitions from database (730). After receiving the policy definitions, get policy process 700 stores the policy definitions at a particular policy engine (740) and stops (750).

In an embodiment, FIG. 8 may be a flowchart of get change identification process 800. Get change identification process 800 starts (802) and a policy engine sends a configuration item identification to the database (810). The policy engine sends the policy engine name to the database (820). The database sends a configuration item change for a configuration item (830). The policy engine receives a change identification for the configuration item change (840). The policy engine stores the change identification (850), and stops (860).

In an embodiment, FIG. 9 may be a flowchart of get change history process 900. Get change history process 900 starts and a policy engine sends a configuration item identification to the database (910). The policy engine sends its name to the database (920), and in return, receives a change history for the configuration item from the database (930). The policy engine stores the change history at the policy engine (940) and stops (950).

In an embodiment, FIG. 10 may be a flowchart of a get configuration item identification list process 1000. Configuration item identification list process starts (1002) and a policy engine sends a configuration item identification to the database (1010). The policy engine sends a configuration item type to the database (1020). The policy engine receives a configuration item identification list from the database (1030), and the policy engine stores the configuration item list at the policy engine (1040), and stops (1050).

In an embodiment, FIG. 11 may be a flowchart of a get configuration item attributes 1100. Get configuration item attributes process 1100 starts (1102) and a policy engine sends a configuration item identification to the database (1110). The policy engine receives configuration item attributes (1120). The policy engine stores the configuration item attributes (1130) and stops (1140).

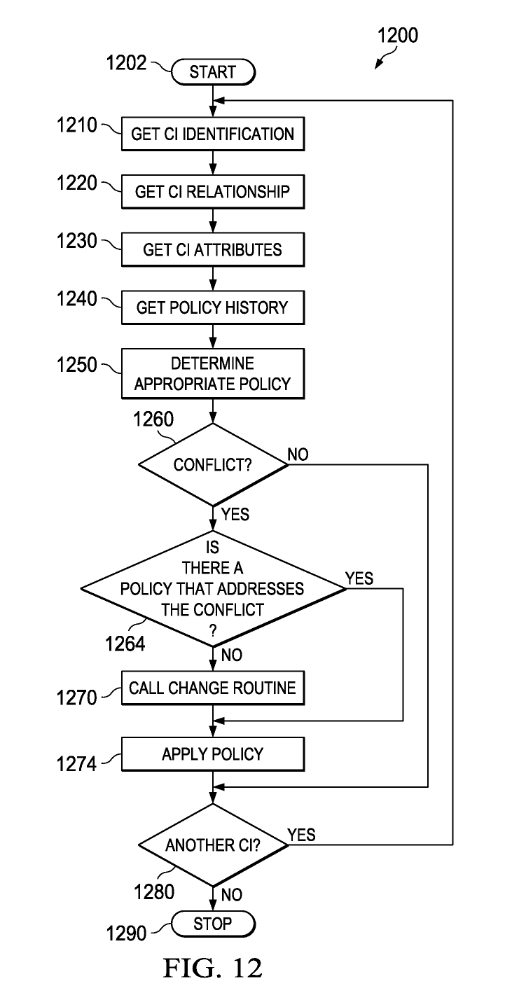

In an embodiment, FIG. 12 may be a flowchart of policy coordination process 1200. Policy coordination process 1200 begins (1202) and the policy engine gets a configuration item identification (1210), gets a configuration item relationship (1220), gets configuration item attributes (1230), gets a policy history (1240), and determines an appropriate policy (1250). A determination may be made whether there is a conflict with the appropriate policy (1260) from step 1250. If there is not a conflict, the appropriate policy may be applied. If there is a conflict, then a determination may be made as to whether there is a policy that addresses the conflict (1264), and if so, that policy may be applied (1274). If there is not a policy that addresses the conflict, then a change routine may be called (1270), and policy coordination process goes to step 1274. When a change routine has been called, the policy applied will be the policy resulting from the change routine. A determination may be made whether there is another configuration item (1280). If there is another configuration item, policy coordination process 1200 goes to step 1210, and if not, stops (1290).

As shown above, relationships are created between the policy data, definition and history, and the managed configuration items. The access of all policy engines to a number of data groups and to policy management data enable coordination of the multiple policy engines. Coordination of multiple policy engines may be further shown in the following scenarios.

In a first scenario, policy engine A 372 and policy engine B 374 may be managing a plurality of servers in management system 340. Policy engine A 372 may be configured to monitor and respond to one or more attacks on management system 340. An attack may be a denial of service due to a hacker intrusion. Policy engine B 374 may be configured to monitor bandwidth usage in order to adjust network resources and a threshold to match a need. If policy engine A 372 and policy engine B 374 act independently of each other, the two policy engines may act in a manner that may be detrimental to data center 310. For example, policy engine A 372 may respond to the hacker intrusion by applying a policy to disable one or more TCP ports and decrease bandwidth. When policy engine A 372 causes one or more TCP ports to be closed, policy engine B 374 may react to the sudden decrease in bandwidth by applying a policy to enable ports and extra bandwidth. In such a situation, the two policy engines would be competing and would not provide effective actions for data center 310.

In a second scenario, policy engine A 372 may be configured to monitor heat in a variety of locations in data center 310. Policy engine A 372 may be configured to apply a policy when a threshold is exceeded. In this case, the threshold would be a specific temperature. Policy engine C 376 may be configured to monitor an ability of a business application to meet a demand when performing mission critical tasks. Policy engine C 376 applies a policy to enable additional central processing units and to increase the speed of the central processing unit of one or more servers that support the business application when the business application may be performing a mission critical task. If policy engine A 372 and policy engine C 376 compete independently, a reduction in central processing unit speed to reduce a temperature by policy engine A 372 could cause policy engine C 376 to increase CPU speed with a resulting condition. However, if policy engine A 372 and policy engine C 376 were coordinated through configuration change database integration, policy engine A 372 would identify servers being managed by the business system policy engine and choose to bypass these while lowering the central processing unit speed of other servers in the environment. Policy engine 372 would know which servers are managed by the business application by accessing a policy history related to the computer system and stored in the configuration management database.

In a third scenario, policy engine B 374 may be managing server backups by applying a policy to ensure that backups are run off-peak. When a first attempt at a backup fails due to a temporary network outage, policy engine B 374 must decide on an appropriate recover action. Policy engine B 374 may read historical data in the configuration management database. After reading historical data in the configuration management database, policy engine B 374 can determine a last successful full backup, and can also determine an average length of time for a plurality of backup operations. Based on knowledge of the last full backup and the average times for a plurality of backup options, policy engine B 374 can apply a policy to perform an incremental backup that achieves the policy in terms of data coverage and off-peak running. Thus, having access to a complete historical configuration item data provides the policy engine with an ability to automate more complex policies.

According to one embodiment, an apparatus comprises a data center having a plurality of configuration items and connected to a network; a database connected to the network; a plurality of policy engines connected to the network; wherein each of the plurality of policy engines may be configured to apply one or more policies to the data center in accordance with an awareness of all configuration item changes made by all other policy engines connected to the network; wherein the awareness comprises a plurality of relationships, each relationship being between a policy data and a configuration item.

According to another embodiment, a method comprises storing a plurality of configuration items in a database, connecting the database to a plurality of policy engines by a network, configuring each of the plurality of policy engines to apply one or more policies to the data center in accordance with an awareness of all configuration item changes made by all other policy engines connected to the network, and wherein the awareness comprises a plurality of relationships, each relationship being between a policy data and a configuration item.

According to another embodiment, a program product comprises a computer readable medium; a plurality of instructions stored on the computer readable medium, the plurality of instructions configured to cause a processor of a computer to perform actions comprising configuring each of a plurality of policy engines to apply one or more policies to a data center in accordance with an awareness of all configuration item changes made by all other policy engines connected to the network; wherein the awareness comprises a plurality of relationships, each relationship being between a policy data and a configuration item.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction running system. For the purposes of this description, a computer-usable or computer-readable medium can be any tangible apparatus that can contain, store, communicate, propagate, or transport the program for use by or in connection with the instruction running system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual running of the program code, bulk storage, and cache memories which provide temporary storage of at least some program code in order to reduce the number of times code must be retrieved from bulk storage during running.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening non-public or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An apparatus comprising:
a data center having a plurality of configuration items and connected to a network;
a database connected to the network;
a plurality of policy engines connected to the network;
wherein each of the plurality of policy engines is configured to apply one or more policies to the data center in accordance with an awareness of all configuration item changes made by all other policy engines connected to the network; and
wherein the awareness comprises a plurality of relationships, each relationship being between a policy data and a configuration item.

2. The apparatus of claim 1 further comprising an interface connected to the network;
wherein the database and the interface are configured to allow each of the plurality of policy engines to store one or more policy definitions in the database, and to store one or more policy decision histories in the database; and
wherein each of the plurality of policy engines is configured for automatic coordination with one or more other policy engines of the plurality of policy engines based on a continuous access to any of the one or more other policy engines and prior to application of a policy to the data center based on one or more of a plurality of decision histories stored in the database.

3. The apparatus of claim 1, wherein each of the plurality of policy engines are configured to access a configuration item data and a policy management data.

4. The apparatus of claim 1, wherein each configuration item comprises one or more attributes and one or more relationships.

5. The apparatus of claim 1, wherein a relationship is provided between each policy data and each configuration item.

6. The apparatus of claim 1, wherein each policy engine is configured to select an appropriate policy to apply based on an analysis of a history in the database, and wherein the history provides a list in chronological order of all configuration item changes made by all policy engines connected to the network.

7. The apparatus of claim 1 further comprising:
an interface providing access to a history of policy data.

8. The apparatus of claim 1 further comprising:
a system for monitoring the managed data center.

9. The apparatus of claim 1 further comprising:
a system for managing the data center.

10. The apparatus of claim 1 further comprising:
a system for discovering dependencies and relationships.

11. The apparatus of claim 1 further comprising:
a system for managing policies.

12. A method comprising:
storing a plurality of configuration items in a database;
connecting the database to a plurality of policy engines by a network;
configuring each of the plurality of policy engines to apply one or more policies to the data center in accordance with an awareness of all configuration item changes made by all other policy engines connected to the network; and
wherein the awareness comprises a plurality of relationships, each relationship being between a policy data and a configuration item.

13. The method of claim 12 further comprising:
connecting an interface connected to the network;
configuring the database and the interface to allow each of the plurality of policy engines to store one or more policy definitions in the database, and to store one or more policy decision histories in the database; and
configuring each of the plurality of policy engines for automatic coordination with one or more other policy engines of the plurality of policy engines based on a continuous access to any of the one or more other policy engines and prior to application of a policy to the data center based on one or more of a plurality of decision histories stored in the database.

14. The method of claim 12 further comprising:
configuring each of the plurality of policy engines to access a configuration item data and a policy management data.

15. The method of claim 12 wherein each configuration item comprises one or more attributes and one or more relationships.

16. The method of claim 12 further comprising:
providing a relationship between each policy data and each configuration item.

17. The method of claim 12 further comprising:
configuring each policy engine to select an appropriate policy to apply based on an analysis of a history in the database, wherein the history provides a list in chronological order of all configuration item changes made by all policy engines connected to the network.

18. The method of claim 12 further comprising:
providing an interface for access to a history of policy data.

19. The method of claim 12 further comprising:
providing a system for monitoring the managed data center and connecting the system to the database and to the plurality of policy engines.

20. The method of claim 12 further comprising:
providing a system for managing the data center.

21. The method of claim 12 further comprising:
providing a system for discovering dependencies and relationships.

22. The method of claim 12 further comprising:
providing a system for managing policies.

23. A program product, comprising:
a computer readable medium;
a plurality of instructions stored on the computer readable medium, the plurality of instructions configured to cause a processor of a computer to perform actions comprising:
configuring each of a plurality of policy engines to apply one or more policies to a data center in accordance with an awareness of all configuration item changes made by all other policy engines connected to the network;
wherein the awareness comprises a plurality of relationships, each relationship being between a policy data and a configuration item.

24. The program product of claim 23, wherein the plurality of instructions further comprises:
connecting an interface connected to the network;
configuring the database and the interface to allow each of the plurality of policy engines to store one or more policy definitions in the database, and to store one or more policy decision histories in the database; and
configuring each of the plurality of policy engines for automatic coordination with one or more other policy engines of the plurality of policy engines based on a continuous access to any of the one or more other policy engines and prior to application of a policy to the data center based on one or more of a plurality of decision histories stored in the database.

25. The program product of claim 24, wherein the plurality of instructions further comprises:
configuring each of the plurality of policy engines to access a configuration item data and a policy management data, wherein each configuration item comprises one or more attributes and one or more relationships;
providing a relationship between each policy data and each configuration item;
configuring each policy engine to select an appropriate policy to apply based on an analysis of a history in the database wherein the history provides a list in chronological order of all configuration item changes made by all policy engines connected to the network;
providing a system for monitoring the managed data center and connecting the system to the database and to the plurality of policy engines;
providing a system for managing the data center; and
providing a system for discovering dependencies and relationships.
